(19) United States
(12) Patent Application Publication
(10) Pub. No.: US 2025/0258037 A1
(43) Pub. Date: Aug. 14, 2025

(54) PULSED LIGHT MEASUREMENT METHOD, NON-TRANSITORY COMPUTER READABLE MEDIUM, AND OPTICAL SPECTRUM ANALYZER

(71) Applicants: Yokogawa Electric Corporation, Tokyo (JP); Yokogawa Test & Measurement Corporation, Tokyo (JP)

(72) Inventor: Ryo Kogai, Tokyo (JP)

(73) Assignees: Yokogawa Electric Corporation, Tokyo (JP); Yokogawa Test & Measurement Corporation, Tokyo (JP)

(21) Appl. No.: 18/978,395

(22) Filed: Dec. 12, 2024

(30) Foreign Application Priority Data
Feb. 14, 2024 (JP) 2024-020670

(51) Int. Cl. G01J 3/10; G01J 3/30

(52) U.S. Cl. CPC G01J 3/10; G01J 3/30

(57) ABSTRACT

A pulsed light measurement method for measuring an optical spectrum of pulsed light includes setting an overlap width of wavelengths at which light intensity is measured in each sweep among a plurality of sweeps performed in a measurement wavelength range of the optical spectrum, starting each sweep among the plurality of sweeps after a delay time, determined based on the overlap width, elapses after detection of a trigger of a gate signal synchronized with the pulsed light, and synthesizing and displaying the optical spectrum from a plurality of waveforms obtained by performing the plurality of sweeps.

### CROSS-REFERENCE TO RELATED APPLICATION

The present application claims priority to Japanese Patent Application No. 2024-20670 filed on Feb. 14, 2024, the entire contents of which are incorporated herein by reference.

### TECHNICAL FIELD

The present disclosure relates to a pulsed light measurement method, a non-transitory computer readable medium, and an optical spectrum analyzer.

### BACKGROUND

Optical spectrum analyzers using gratings are known, as described in Patent Literature (PTL) 1.

### CITATION LIST

### Patent Literature

PTL 1: JP 5339027 B2

### SUMMARY

A pulsed light measurement method according to some embodiments is a method for measuring an optical spectrum of pulsed light. The pulsed light measurement method includes setting an overlap width of wavelengths at which light intensity is measured in each sweep among a plurality of sweeps performed in a measurement wavelength range of the optical spectrum, starting each sweep among the plurality of sweeps after a delay time, determined based on the overlap width, elapses after detection of a trigger of a gate signal synchronized with the pulsed light, and synthesizing and displaying the optical spectrum from a plurality of waveforms obtained by performing the plurality of sweeps.

A non-transitory computer readable medium according to some embodiments stores a pulsed light measurement program configured to cause an optical spectrum analyzer for measuring an optical spectrum of pulsed light to perform operations, the operations including setting an overlap width of wavelengths at which light intensity is measured in each sweep among a plurality of sweeps performed in a measurement wavelength range of the optical spectrum, starting each sweep among the plurality of sweeps after a delay time, determined based on the overlap width, elapses after detection of a trigger of a gate signal synchronized with the pulsed light, and synthesizing and displaying the optical spectrum from a plurality of waveforms obtained by performing the plurality of sweeps.

An optical spectrum analyzer according to several embodiments includes a measurement unit configured to measure an optical spectrum of pulsed light, and a light detector configured to detect a light intensity at each wavelength of the pulsed light. The measurement unit is configured to set an overlap width of wavelengths at which light intensity is measured in each sweep among a plurality of sweeps performed in a measurement wavelength range of the optical spectrum. The light detector is configured to start each sweep among the plurality of sweeps after a delay time, determined based on the overlap width, elapses after detection of a trigger of a gate signal synchronized with the pulsed light. The measurement unit is configured to synthesize and display the optical spectrum from a plurality of waveforms obtained by performing the plurality of sweeps.

### BRIEF DESCRIPTION OF THE DRAWINGS

In the accompanying drawings:

FIG. 1A is a timing chart of a first sweep in a measurement method according to a comparative example;

FIG. 1B is a waveform of data measured by the sweep in FIG. 1A;

FIG. 2A is a timing chart of a second sweep in the measurement method according to the comparative example;

FIG. 2B is a waveform of data measured by the sweep in FIG. 2A;

FIG. 3 is a waveform yielded by synthesizing the waveforms in FIG. 2A and FIG. 2B;

FIG. 4 is a block diagram illustrating an example configuration of an optical spectrum analyzer according to an embodiment of the present disclosure;

FIG. 5 is a flowchart illustrating example procedures of a pulsed light measurement method according to the present disclosure;

FIG. 6A is a timing chart of a first sweep in a measurement method according to the present disclosure;

FIG. 6B is a waveform of data measured by the sweep in FIG. 6A;

FIG. 7A is a timing chart of a second sweep in a measurement method according to the present disclosure;

FIG. 7B is a waveform of data measured by the sweep in FIG. 7A;

FIG. 8A is a timing chart of a third sweep in a measurement method according to the present disclosure;

FIG. 8B is a waveform of data measured by the sweep in FIG. 8A;

FIG. 9A is a timing chart of a fourth sweep in a measurement method according to the present disclosure;

FIG. 9B is a waveform of data measured by the sweep in FIG. 9A;

FIG. 10 is a waveform yielded by synthesizing the waveforms in FIG. 6B, FIG. 7B, FIG. 8B, and FIG. 9B;

FIG. 11 is a diagram illustrating an example of a screen for setting the waveform overlap width; and

FIG. 12 is a diagram illustrating an example of distinguishing among and displaying the data measured in each sweep.

### DETAILED DESCRIPTION

When measuring an optical spectrum using a grating, an optical spectrum analyzer rotates the grating at an angle corresponding to each wavelength from a start wavelength to an end wavelength of a measurement wavelength range and measures the optical spectrum, which is the light intensity for each wavelength. The operation of rotating the grating at an angle corresponding to each wavelength and measuring the optical spectrum is also called a sweep.

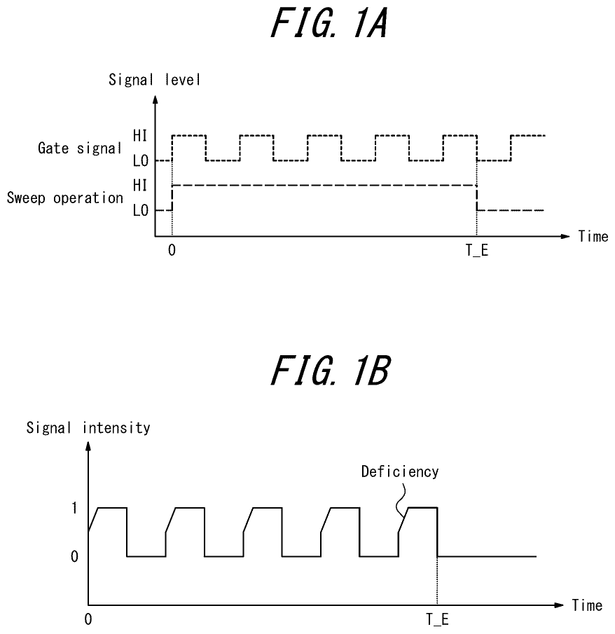

In the case of measuring the optical spectrum of pulsed light by performing a sweep, the optical spectrum data is obtained at the timing at which the pulsed light is being emitted, i.e., the timing at which a gate signal synchronized with the pulsed light is HI, but is not obtained at the timing at which the pulsed light is not being emitted, i.e., the timing at which the gate signal is LO, as illustrated in FIGS. 1A and 1B.

Therefore, in order to complete the acquisition of optical spectrum data for all wavelengths within the measurement wavelength range, the spectrum data for one pulse period is acquired by performing multiple measurements while shifting the phase of the pulse signal. The smaller the amount of phase shift, i.e., the greater the number of measurements, the larger the overlap width of the waveform obtained in each measurement. The larger the overlap width of the waveforms, the better the quality of the waveform of the measured optical spectrum.

On the other hand, the greater the number of measurements, the longer it takes to measure the optical spectrum. In other words, there is a trade-off between the length of the measurement time and the quality of the waveform of the measured optical spectrum. Demand exists for improving user convenience by shortening the measurement time while ensuring the quality of the waveform of the optical spectrum.

The pulsed light measurement method, non-transitory computer readable medium, and optical spectrum analyzer according to the present disclosure improve user convenience.

(1) A pulsed light measurement method according to some embodiments is a method for measuring an optical spectrum of pulsed light. The pulsed light measurement method includes setting an overlap width of wavelengths at which light intensity is measured in each sweep among a plurality of sweeps performed in a measurement wavelength range of the optical spectrum, starting each sweep among the plurality of sweeps after a delay time, determined based on the overlap width, elapses after detection of a trigger of a gate signal synchronized with the pulsed light, and synthesizing and displaying the optical spectrum from a plurality of waveforms obtained by performing the plurality of sweeps.

The ability to set the overlap width of wavelengths when performing a plurality of sweeps both ensures the quality of the waveform of the optical spectrum and reduces the measurement time. Consequently, user convenience improves.

(2) According to an embodiment, in the pulsed light measurement method according to (1), when the optical spectrum is synthesized from the plurality of waveforms, an intensity detected during a period in which waveform data has no deficient data may be adopted as the light intensity at overlapping wavelengths in the plurality of waveforms. With this configuration, deficient data is eliminated in the synthesized waveform. Consequently, the quality of the waveform improves.

(3) According to an embodiment, in the pulsed light measurement method according to (1), when the optical spectrum is synthesized from the plurality of waveforms in a case in which the delay time is increased in an order in which the plurality of sweeps is performed, a value obtained by performing a later sweep may be adopted as the light intensity at overlapping wavelengths in the plurality of waveforms. With this configuration, the waveforms acquired in the previously performed sweeps need not be stored. Consequently, the process of synthesizing the waveform is simplified.

(4) According to an embodiment, in the pulsed light measurement method according to (1), when the optical spectrum is synthesized from the plurality of waveforms in a case in which the delay time is increased in an order in which the plurality of sweeps is performed, an intensity detected during a later sweep, among intensities detected during a period in which waveform data has no deficient data, may be adopted as the light intensity at overlapping wavelengths in the plurality of waveforms.

(5) According to an embodiment, in the pulsed light measurement method according to (1), when the optical spectrum is synthesized from the plurality of waveforms, the larger value may be adopted as the light intensity at overlapping wavelengths in the plurality of waveforms.

(6) According to an embodiment, in the pulsed light measurement method according to (1), when the optical spectrum is synthesized from the plurality of waveforms, the larger value among intensities detected during a period in which waveform data has no deficient data may be adopted as the light intensity at overlapping wavelengths in the plurality of waveforms.

(7) According to an embodiment, the pulsed light measurement method according to any one of (1) to (6) may further include setting the overlap width as a percentage of a pulse width of the pulsed light. By the overlap width being set as a percentage of the pulse width, the user can more easily achieve a sensory understanding of the overlap width. Consequently, user convenience improves.

(8) According to an embodiment, the pulsed light measurement method according to (7) may further include determining a number of times to perform the sweep based on the pulse width and the overlap width. This configuration makes it easier to understand the measurement time.

(9) According to an embodiment, the pulsed light measurement method according to any one of (1) to (8) may further include displaying the plurality of waveforms obtained by the plurality of sweeps in a distinguishable manner. By the waveforms acquired in each of the sweeps being displayed in a manner distinguishable from each other, the user can more easily determine how to set the overlap width. Consequently, user convenience improves.

(10) According to an embodiment, the pulsed light measurement method according to any one of (1) to (9) may further include accepting input for setting the overlap width while performing the plurality of sweeps. By input for setting the overlap width being accepted while the plurality of sweeps is being performed, the user can immediately check how the setting of the overlap width changes the synthesized waveform and can more easily determine how to set the overlap width. Consequently, user convenience improves.

(11) According to an embodiment, the pulsed light measurement method according to any one of (1) to (10) may further include accepting input for setting the overlap width while displaying a waveform of the optical spectrum. By input for setting the overlap width being accepted while the waveform is being displayed, the user can more easily determine how to set the overlap width. Consequently, user convenience improves.

(12) A non-transitory computer readable medium according to some embodiments stores a pulsed light measurement program configured to cause an optical spectrum analyzer for measuring an optical spectrum of pulsed light to perform operations, the operations including setting an overlap width of wavelengths at which light intensity is measured in each sweep among a plurality of sweeps performed in a measurement wavelength range of the optical spectrum, starting each sweep among the plurality of sweeps after a delay time, determined based on the overlap width, elapses after detection of a trigger of a gate signal synchronized with the pulsed light, and synthesizing and displaying the optical spectrum from a plurality of waveforms obtained by performing the plurality of sweeps.

(13) An optical spectrum analyzer according to several embodiments includes a measurement unit configured to measure an optical spectrum of pulsed light, and a light detector configured to detect a light intensity at each wavelength of the pulsed light. The measurement unit is configured to set an overlap width of wavelengths at which light intensity is measured in each sweep among a plurality of sweeps performed in a measurement wavelength range of the optical spectrum. The light detector is configured to start each sweep among the plurality of sweeps after a delay time, determined based on the overlap width, elapses after detection of a trigger of a gate signal synchronized with the pulsed light. The measurement unit is configured to synthesize and display the optical spectrum from a plurality of waveforms obtained by performing the plurality of sweeps.

The present disclosure relates to an optical spectrum analyzer that measures the optical spectrum of pulsed light. In the present disclosure, it is assumed that the grating method is adopted as a measurement method. When measuring an optical spectrum of pulsed light, an optical spectrum analyzer based on the grating method rotates a grating at an angle corresponding to each wavelength from a start wavelength to an end wavelength of a measurement wavelength range and measures the optical spectrum, which is the light intensity for each wavelength. The operation of rotating the grating at an angle corresponding to each wavelength and measuring the optical spectrum is also called a sweep.

In the case of measuring pulsed light, an optical spectrum analyzer can measure the optical spectrum at wavelengths corresponding to periods when the pulsed light is on but cannot measure the optical spectrum at wavelengths corresponding to periods when the pulsed light is off. Here, both a period when the pulsed light is on and a period when the pulsed light is off are included during the performance of one sweep. To measure the light intensity at all wavelengths in the wavelength measurement range, a plurality of sweeps must be performed.

In the case of measuring pulsed light, the optical spectrum analyzer performs a plurality of sweeps by shifting the phase with respect to the signal synchronized with the pulsed light, so that the period when the pulsed light is turned on occurs in at least one sweep for all wavelengths in the measurement wavelength range. The phase shift when performing each sweep is controlled by delaying the start of each sweep relative to the timing when the trigger of the signal synchronized with the pulsed light is detected. The optical spectrum analyzer measures the optical spectrum over the entire measurement wavelength range by synthesizing the measurement data obtained in each sweep.

The optical spectrum analyzer shifts the phase when executing each sweep according to the duty ratio of the pulsed light, so that the period when the pulsed light is turned on occurs in at least one sweep for all wavelengths in the measurement wavelength range. Here, the amount of phase shift when executing each sweep affects the measurement results of the optical spectrum.

Specifically, the smaller the amount of phase shift in each sweep, the larger the overlap width of wavelengths for which the intensity can be acquired in each sweep. The larger the overlap width of the wavelengths, the better the quality of the waveform of the measured optical spectrum. On the other hand, when the amount of phase shift is decreased, the number of measurements required to generate a period when the pulsed light is turned on for all wavelengths in the measurement wavelength range increases. The greater the number of measurements, the longer it takes to measure the optical spectrum. In other words, there is a trade-off between the length of the measurement time and the quality of the waveform of the measured optical spectrum. Demand exists for adjusting the balance between the measurement time of the optical spectrum and the quality of the measured waveform.

Therefore, according to the present disclosure, the overlap width of wavelengths for which intensity can be acquired in each sweep is set in the optical spectrum analyzer. The user can set the overlap width of wavelengths while viewing the measured waveform. The balance between the measurement time of the optical spectrum and the quality of the measured waveform is thereby adjusted.

Embodiments of the present disclosure are described below while being compared to a comparative example.

### Comparative Example

In the comparative example, assume that the duty ratio of the pulsed light to be measured by the optical spectrum analyzer is 50%. The intensity of each wavelength of the pulsed light is assumed to be uniform.

The optical spectrum analyzer starts the sweep triggered by a gate signal synchronized with the pulsed light. As illustrated in the timing chart in FIG. 1A, the gate signal is represented by two signal levels, HI and LO. The signal level of the gate signal is assumed to be HI in synchronization with the period when the pulsed light is on. The signal level of the gate signal is assumed to be LO in synchronization with the period when the pulsed light is off.

In FIG. 1A, the optical spectrum analyzer starts the first sweep operation, taking the rising of the gate signal as a trigger. The rising of the gate signal means that the signal level of the gate signal goes from LO to HI. The signal level of the sweep operation is assumed to be represented by HI during the period when the optical spectrum analyzer is performing the sweep operation. The time required for the optical spectrum analyzer to move the grating so as to cover the entire measurement wavelength range is assumed to be represented by T_E.

By executing the sweep operation at the timing illustrated in the timing chart in FIG. 1A, the waveform illustrated in FIG. 1B is obtained as the optical spectrum of the pulsed light in the measurement wavelength range. The time on the horizontal axis of FIG. 1B is represented as 0 when the sweep operation is started. In a case in which the duty ratio of the pulsed light is 50%, the intensity of the optical spectrum is obtained in 50% of the measurement wavelength range.

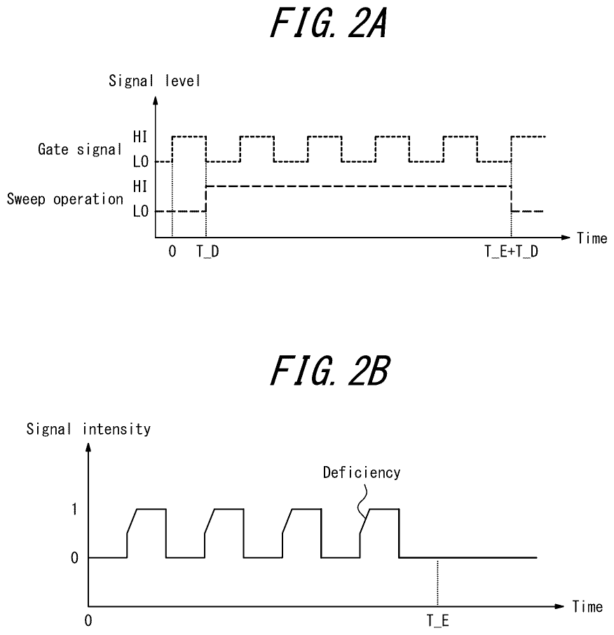

In the comparative example, the optical spectrum analyzer starts a second sweep operation at a time delayed by T_D from the time 0 when the gate signal rises, as illustrated in FIG. 2A. T_D is also referred to as the delay time. In FIG. 2A, the delay time T_D is set to 100% of the pulse width of the pulsed light, i.e., 100% of the pulse width of the gate signal. The pulse width represents the length of the period during which the pulsed light is on.

By executing the sweep operation at the timing illustrated in the timing chart in FIG. 2A, the waveform illustrated in FIG. 2B is obtained as the optical spectrum of the pulsed light in the measurement wavelength range. The time on the horizontal axis of FIG. 2B is represented as 0 when the sweep operation is started. By the delay time T_D being set to 100% of the pulse width, the range over which the intensity of the optical spectrum in FIG. 2B is obtained complements the range over which the intensity of the optical spectrum in FIG. 1B is obtained. In other words, the intensity in FIG. 2B is acquired for the wavelengths for which the intensity was not acquired in FIG. 1B.

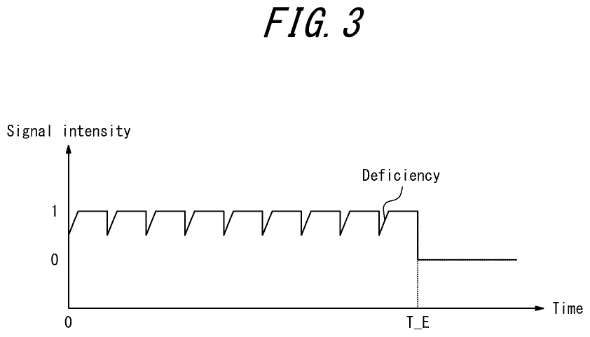

By synthesis of the waveform obtained in the first sweep operation illustrated in FIG. 1B and the waveform obtained in the second sweep operation illustrated in FIG. 2B, the waveform of the optical spectrum of the pulsed light is generated as illustrated in FIG. 3.

Here, the waveform of the optical spectrum of the pulsed light illustrated in FIGS. 1B and 2B has deficiencies in the wavelength at the initial rise of the pulsed light. A deficiency is a state such that the measured result is smaller than the light intensity that should in fact be measured. The range over which the intensity is obtained in the waveform in FIG. 1B corresponds to the range over which intensity is not obtained in the waveform in FIG. 2B. Conversely, the range over which the intensity is not obtained in the waveform in FIG. 1B corresponds to the range over which intensity is obtained in the waveform in FIG. 2B. The waveforms of FIG. 1B and FIG. 2B are therefore synthesized without overlapping each other. As a result, the waveform illustrated in FIG. 3 still has deficiencies.

The quality of the waveform of the optical spectrum is degraded as a result of the deficiencies remaining in the waveform of the optical spectrum. Here, in the case of a deficiency in a certain waveform, the deficiency could be compensated for by performing a different sweep to detect the intensity in the range containing the deficiency. Specifically, a plurality of sweeps could be performed by adjusting the delay time so that no deficiencies remain in the waveform.

In the comparative example, it is assumed that the delay time is determined in light of the deficiencies illustrated in FIGS. 1B and 2B. However, the length of time from the rise of the pulsed light until the deficiency occurs may vary. The delay time could be set to a longer time to ensure leeway when determining the delay time, but the longer the delay time, the longer the measurement time. Demand exists for both maintaining the quality of the waveform of the optical spectrum and shortening the measurement time.

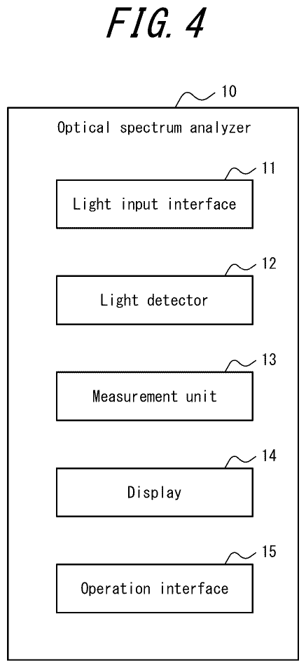

In the present disclosure, a pulsed light measurement method, a pulsed light measurement program, and an optical spectrum analyzer 10 (see FIG. 4) that can adjust the balance between the measurement time of the optical spectrum and the quality of the measured waveform are described below.

### Example Configuration of Optical Spectrum Analyzer 10

As illustrated in FIG. 4, the optical spectrum analyzer 10 according to an embodiment of the present disclosure includes a light input interface 11, a light detector 12, a measurement unit 13, a display 14, and an operation interface 15.

The light input interface 11 is configured to include an input port. The input port is configured to enable the optical spectrum analyzer 10 to receive input of pulsed light to be measured.

The light detector 12 is configured to include a spectrometer and a light receiving element. The spectrometer separates the pulsed light into light of various wavelengths and passes the light of the wavelength to be detected. In the present disclosure, it is assumed that a grating is used as the spectrometer. The light detector 12 moves the grating and performs a sweep under control instructions from the measurement unit 13 to detect the light intensity at each wavelength in the measurement wavelength range.

The measurement unit 13 controls the timing at which the light detector 12 starts a sweep operation and causes the light detector 12 to perform the sweep operation a plurality of times. The measurement unit 13 acquires the detection result in each sweep from the light detector 12 and generates the waveform of the optical spectrum of the pulsed light by synthesizing the waveforms in the detection results.

The measurement unit 13 may, for example, be configured by a processor such as a central processing unit (CPU). The measurement unit 13 may implement predetermined functions by having the processor execute a predetermined program. The measurement unit 13 may, for example, be configured to include a dedicated circuit, such as a Field Programmable Gate Array (FPGA).

The measurement unit 13 may include a memory. The memory stores various information used in the operation of the optical spectrum analyzer 10, programs for implementing the functions of the optical spectrum analyzer 10, and the like. The memory may function as a working memory of the measurement unit 13. The memory may, for example, be a semiconductor memory. The memory may be configured to include volatile memory or non-volatile memory. At least a portion of the memory may be configured as a memory device connected externally to the optical spectrum analyzer 10.

The measurement unit 13 may be realized as a computer, such as a desktop Personal Computer (PC) or notebook PC, that is connected externally to the optical spectrum analyzer 10.

The display 14 may be configured to include various displays, such as a liquid crystal display. The display 14 may be configured as a touch panel display that displays a graphical user interface (GUI) functioning as the operation interface 15 and accepts input from the user. In other words, the display 14 may be configured integrally with the operation interface 15.

The operation interface 15 may be configured to include an input device that accepts input from the user. The input device may, for example, include a keyboard or physical keys, a touch panel or touch sensor, or a pointing device such as a mouse. The operation interface 15 may be configured as a touch panel display integrated with the display 14 as described above. The operation interface 15 is also referred to simply as an input interface.

### Operation Example of Optical Spectrum Analyzer 10

The optical spectrum analyzer 10 generates the waveform of an optical spectrum of pulsed light. By performing one sweep, the optical spectrum analyzer 10 can acquire the waveform of the optical spectrum of some wavelengths in the waveform of the optical spectrum of all wavelengths in the measurement wavelength range of the pulsed light. The optical spectrum analyzer 10 synthesizes the waveform acquired in each sweep among the plurality of sweeps to generate the waveform of the optical spectrum of all wavelengths in the measurement wavelength range of the pulsed light. The waveform resulting from synthesizing the waveform acquired in each sweep among the plurality of sweeps is also referred to as a synthesized waveform.

Here, the waveform acquired in one sweep is the waveform at the wavelengths corresponding to the period when the pulsed light is on. When the period when the pulsed light is on begins, a deficiency occurs in the waveform at the initial rise of the pulsed light. The deficiency degrades the quality of the waveform of the optical spectrum of the pulsed light. The wavelength range where the waveform has a deficiency is also referred to as the deficient range.

The deficient range in the waveform acquired in one sweep is complemented by acquiring waveforms in the same wavelength range in other sweeps so as to eliminate the deficiency. The optical spectrum analyzer 10 according to the present disclosure is configured so that the wavelength overlap width of the waveform acquired in each sweep among the plurality of sweeps can be set for the deficient range to be complemented by the waveforms acquired in the other sweeps. By being able to set the overlap width of wavelengths, the user can set the overlap width of wavelengths by looking at the measured waveforms. The balance between the measurement time of the optical spectrum and the quality of the measured waveform is thereby adjusted.

Specific examples of the operation of the optical spectrum analyzer 10 according to the present disclosure are described below.

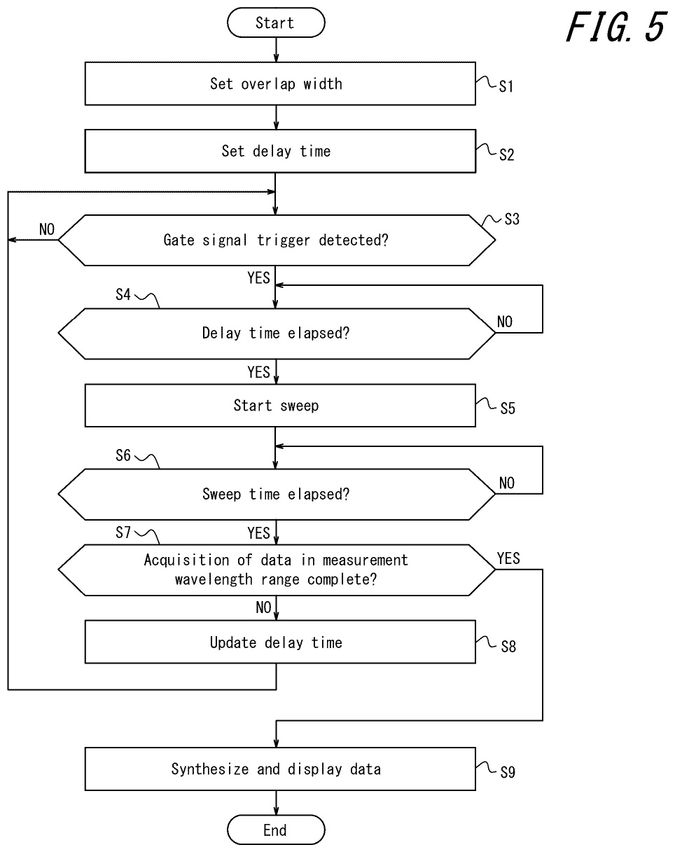

The optical spectrum analyzer 10 may execute a pulsed light measurement method including the procedures in the flowchart illustrated in FIG. 5. The pulsed light measurement method may be realized as a pulsed light measurement program to be executed by the optical spectrum analyzer 10. The pulsed light measurement program may be stored on a non-transitory computer readable medium.

The measurement unit 13 sets the overlap width (step S1). The overlap width is expressed as a percentage of the length of the pulse width of the pulsed light. In the present disclosure, the overlap width is set to Y %, where Y is set to a value greater than 0% and less than 100%. In the present disclosure, Y is set to 50%. The duty ratio of the pulsed light is expressed as X % and is assumed to be 50% in the present disclosure. In this case, the overlap width corresponds to a length of 25% of the pulse period. The measurement unit 13 may set the overlap width based on setting input from the user, as described below. By the overlap width being set as a percentage of the pulse width, the user can more easily achieve a sensory understanding of the overlap width. Consequently, user convenience improves.

The measurement unit 13 sets a delay time in the light detector 12 (step S2). When the light detector 12 performs a plurality of sweeps, the delay time is the time to delay the timing at which the light detector 12 starts each sweep from the timing of the rising of the gate signal synchronized with the pulsed light. By extending the delay time when performing a plurality of sweeps in order, the measurement unit 13 can overlap the wavelengths of the waveform acquired in each sweep so that the waveforms acquired in other sweeps complement the deficient range of the waveform acquired in one sweep. The measurement unit 13 sets the delay time to zero when executing the first sweep.

The light detector 12 determines whether a gate signal trigger has been detected (step S3). A gate signal trigger is a trigger caused by a change in the signal level of the gate signal. In the present disclosure, a gate signal trigger is assumed to occur when the gate signal rises.

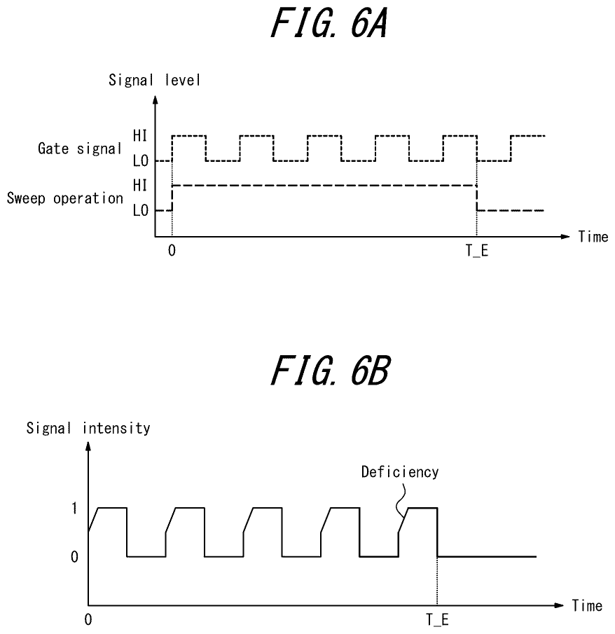

As illustrated in FIG. 6A, a gate signal trigger is considered to have occurred when the signal level of the gate signal goes from LO to HI in the first sweep. The time when the gate signal trigger occurs is assumed to be represented by 0.

In a case in which a gate signal trigger has not been detected (step S3: NO), the light detector 12 repeats the determination procedure in step S3 until detecting a gate signal trigger.

In the case in which a gate signal trigger has been detected (step S3: YES), the light detector 12 determines whether a delay time has elapsed since detection of the gate signal trigger (step S4). In a case in which the delay time is set to zero, the light detector 12 determines that the delay time has elapsed when the gate signal trigger is detected.

In a case in which the delay time has not elapsed (step S4: NO), the light detector 12 repeats the determination procedure in step S4 until the delay time has elapsed.

In a case in which the delay time has elapsed (step S4: YES), the light detector 12 starts a sweep (step S5). As described above, the delay time for the first sweep is set to zero. Therefore, as illustrated in FIG. 6A, the light detector 12 starts the first sweep operation from time 0 at which the gate signal trigger occurs. The period during which the sweep operation is performed is assumed to be represented as the state in which the signal level of the sweep operation is HI.

The light detector 12 determines whether a sweep time has elapsed (step S6). The sweep time is the time required to move the grating so that the intensity of all wavelengths in the measurement wavelength range can be measured. The sweep time is represented by T_E. In a case in which the sweep time has not elapsed (step S6: NO), the light detector 12 repeats the determination procedure in step S6 until the sweep time has elapsed and continues sweeping over the entire measurement wavelength range.

In a case in which the sweep time has elapsed (step S6: YES), the light detector 12 ends the first sweep operation. In the first sweep operation, the light detector 12 can detect the waveform measured for the wavelength range corresponding to the period when the pulsed light is on, as illustrated in FIG. 6B.

The horizontal axis in FIG. 6B represents time. This time corresponds to each wavelength in the measurement wavelength range. Time 0 corresponds to the minimum wavelength in the measurement wavelength range. Time T_E corresponds to the maximum wavelength in the measurement wavelength range. The vertical axis represents the light intensity at each wavelength, with the maximum value being 1.

The light detector 12 outputs the detected waveform to the measurement unit 13.

After one sweep operation by the light detector 12 is finished, the measurement unit 13 determines whether the acquisition of data in the measurement wavelength range is complete (step S7). The measurement unit 13 acquires the waveform detected in one sweep operation from the light detector 12. The measurement unit 13 determines that the acquisition of data in the measurement wavelength range is complete in a case in which the waveform is acquired at all wavelengths in the measurement wavelength range.

At the end of the first sweep operation, the measurement unit 13 has only acquired the waveform at some wavelengths in the measurement wavelength range. The measurement unit 13 therefore determines that the acquisition of data in the measurement wavelength range is not complete. In a case in which acquisition of data in the measurement wavelength range is not complete (step S7: NO), the measurement unit 13 updates the delay time set in the light detector 12 in order to execute the next sweep (step S8).

As described above, the measurement unit 13 extends the delay time when performing a plurality of sweeps in order. In other words, the measurement unit 13 sets a time that is extended from the delay time set when performing the previous sweep as the delay time when performing the next sweep. The time by which the delay time is extended is calculated as the length of the pulse width of the pulsed light multiplied by (1−Y/100) in a case in which the overlap width of the pulsed light is expressed as Y %. In a case in which the duty ratio of the pulsed light is expressed as X %, the length of the pulse width is calculated as the length of the pulse period multiplied by (X/100). The time by which the delay time is extended is therefore calculated as the length of the pulse period of the pulsed light multiplied by (X/100)×(1−Y/100). For example, if the pulse period of the pulsed light is 0.1 seconds, the duty ratio (X) of the pulsed light is 25%, and the overlap width (Y) is 10%, then the time by which the delay time is extended is calculated to be 0.0225 seconds by calculating 0.1×(25/100)×(1−10/100).

In the present disclosure, the duty ratio (X) of the pulsed light is assumed to be 50%. The overlap width (Y) is set to 50% as described above. The measurement unit 13 updates the delay time for a delay equal to the length of the pulse width of the pulsed light multiplied by 50%, which was set as the overlap width. In this case, the delay time corresponds to a length of 25% of the pulse period, i.e., ¼. The updated delay time is assumed to be represented by T_D1. After the measurement unit 13 updates the delay time, the process returns to the procedure in step S3, and the light detector 12 performs a second sweep operation as the next sweep.

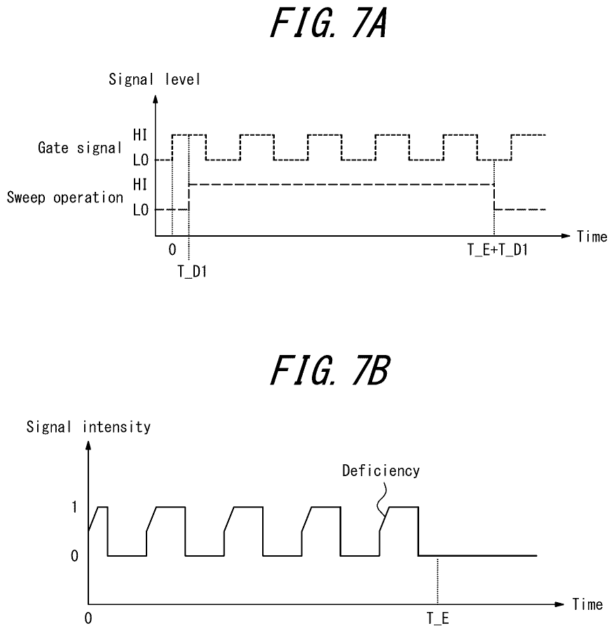

In a case in which the light detector 12 determines that the gate signal trigger has been detected in the procedure in step S3 and the delay time T_D1 has elapsed in the procedure in step S4, the second sweep operation is started from time T_D1 in the procedure in step S5, as illustrated in FIG. 7A. The period during which the sweep operation is performed is assumed to be represented as the state in which the signal level of the sweep operation is HI. In the procedure in step S6, the light detector 12 continues the second sweep operation until completion at time T_E+T_D1.

The light detector 12 can detect the waveform illustrated in FIG. 7B during the second sweep operation. The time on the horizontal axis in FIG. 7B is indicated as the time in FIG. 7A minus T_D1 to match the relationship between the measurement wavelength range and time in FIG. 6B. In other words, the time at which the sweep starts is represented by 0. The time at which the sweep ends is represented by T_E. Time 0 on the horizontal axis in FIG. 7B corresponds to the minimum wavelength in the measurement wavelength range. Time T_E corresponds to the maximum wavelength in the measurement wavelength range. The vertical axis represents the light intensity at each wavelength, with the maximum value being 1.

In comparing the waveform in FIG. 7B and the waveform in FIG. 6B, the wavelength range detected in the waveform in FIG. 7B has moved to the shorter wavelength side than the wavelength range detected in the waveform in FIG. 6B by ¼ the length of the pulse period, i.e., by a phase of 90°. However, even when the waveform in FIG. 6B and the waveform in FIG. 7B are synthesized, there remain wavelengths in the measurement wavelength range for which no waveform has been acquired. The measurement unit 13 therefore determines that the acquisition of data in the measurement wavelength range is not complete and updates the delay time set in the light detector 12 in the procedure in step S8.

The measurement unit 13 updates the delay time, as the delay time when performing a third sweep operation, for a delay equal to the length of the pulse width of the pulsed light multiplied by 50%, which was set as the overlap width, from the delay time when performing the second sweep operation. The updated delay time is assumed to be represented by T_D2. After the measurement unit 13 updates the delay time, the process returns to the procedure in step S3, and the light detector 12 performs the third sweep operation as the next sweep.

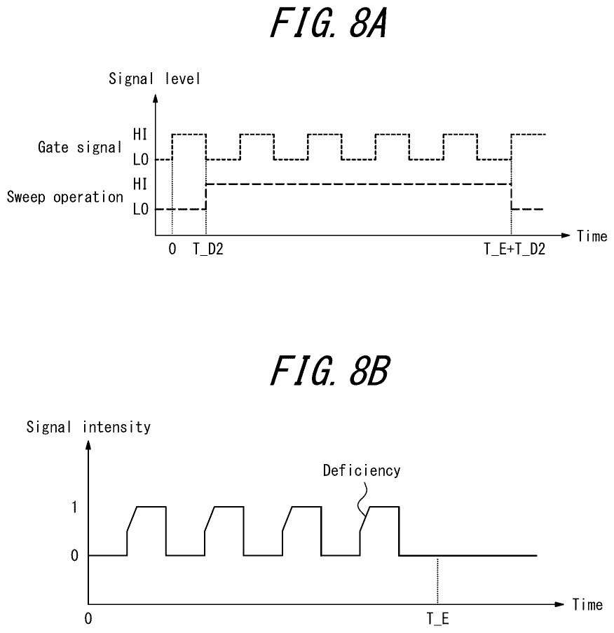

In a case in which the light detector 12 determines that the gate signal trigger has been detected in the procedure in step S3 and the delay time T_D2 has elapsed in the procedure in step S4, the third sweep operation is started from time T_D2 in the procedure in step S5, as illustrated in FIG. 8A. The period during which the sweep operation is performed is assumed to be represented as the state in which the signal level of the sweep operation is HI. In the procedure in step S6, the light detector 12 continues the third sweep operation until completion at time T_E+T_D2.

The light detector 12 can detect the waveform illustrated in FIG. 8B during the third sweep operation. The time on the horizontal axis in FIG. 8B is indicated as the time in FIG. 8A minus T_D2 to match the relationship between the measurement wavelength range and time in FIGS. 6B and 7B. In other words, the time at which the sweep starts is represented by 0. The time at which the sweep ends is represented by T_E. Time 0 on the horizontal axis in FIG. 8B corresponds to the minimum wavelength in the measurement wavelength range. Time T_E corresponds to the maximum wavelength in the measurement wavelength range. The vertical axis represents the light intensity at each wavelength, with the maximum value being 1.

In comparing the waveform in FIG. 8B and the waveform in FIG. 7B, the wavelength range detected in the waveform in FIG. 8B has moved to the shorter wavelength side than the wavelength range detected in the waveform in FIG. 7B by ¼ the length of the pulse period, i.e., by a phase of 90°. Here, when the waveform in FIG. 6B, the waveform in FIG. 7B, and the waveform in FIG. 8B are synthesized, a waveform for all wavelengths in the measurement wavelength range is acquired. However, the deficient range in the waveform in FIG. 8B does not overlap with the wavelength ranges of the waveforms in FIGS. 6B and 7B. The measurement unit 13 therefore determines that the acquisition of data in the measurement wavelength range is not complete and updates the delay time set in the light detector 12 in the procedure in step S8.

The measurement unit 13 updates the delay time, as the delay time when performing a fourth sweep operation, for a delay equal to the length of the pulse width of the pulsed light multiplied by 50%, which was set as the overlap width, from the delay time when performing the third sweep operation. The updated delay time is assumed to be represented by T_D3. After the measurement unit 13 updates the delay time, the process returns to the procedure in step S3, and the light detector 12 performs the fourth sweep operation as the next sweep.

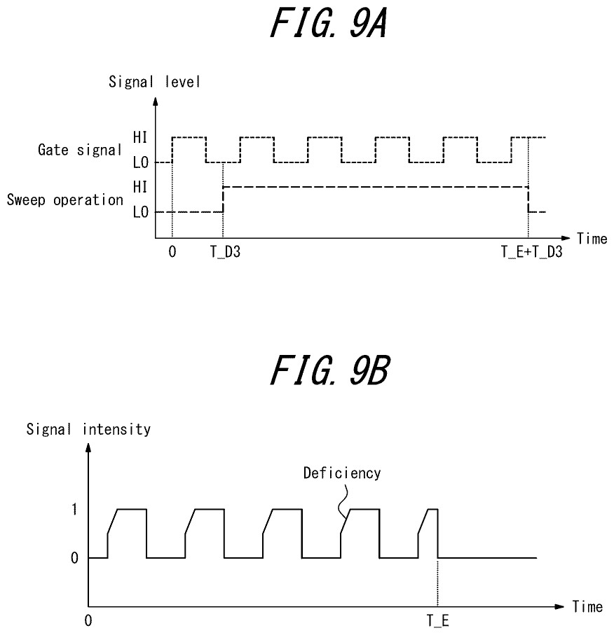

In a case in which the light detector 12 determines that the gate signal trigger has been detected in the procedure in step S3 and the delay time T_D3 has elapsed in the procedure in step S4, the fourth sweep operation is started from time T_D3 in the procedure in step S5, as illustrated in FIG. 9A. The period during which the sweep operation is performed is assumed to be represented as the state in which the signal level of the sweep operation is HI. In the procedure in step S6, the light detector 12 continues the fourth sweep operation until completion at time T_E+T_D3.

The light detector 12 can detect the waveform illustrated in FIG. 9B during the fourth sweep operation. The time on the horizontal axis in FIG. 9B is indicated as the time in FIG. 9A minus T_D3 to match the relationship between the measurement wavelength range and time in FIGS. 6B, 7B, and 8B. In other words, the time at which the sweep starts is represented by 0. The time at which the sweep ends is represented by T_E. Time 0 on the horizontal axis in FIG. 9B corresponds to the minimum wavelength in the measurement wavelength range. Time T_E corresponds to the maximum wavelength in the measurement wavelength range. The vertical axis represents the light intensity at each wavelength, with the maximum value being 1.

In comparing the waveform in FIG. 9B and the waveform in FIG. 8B, the wavelength range detected in the waveform in FIG. 9B has moved to the shorter wavelength side than the wavelength range detected in the waveform in FIG. 8B by ¼ the length of the pulse period, i.e., by a phase of 90°. Here, when the waveform in FIG. 6B, the waveform in FIG. 7B, the waveform in FIG. 8B, and the waveform in FIG. 9B are synthesized, a waveform for all wavelengths in the measurement wavelength range is acquired. The deficient range in the waveform in each of FIG. 6B, FIG. 7B, FIG. 8B, and FIG. 9B overlaps the wavelength range of at least one other waveform. The measurement unit 13 therefore determines that the acquisition of data in the measurement wavelength range is complete.

In the case in which acquisition of data in the measurement wavelength range is complete (step S7: YES), the measurement unit 13 synthesizes the data of the waveform acquired in each sweep and displays the result on the display 14 (step S9). The measurement unit 13 may synthesize the waveforms based on the rules indicated as (1) and (2) below.

(1) The intensity at a wavelength detected in only one sweep is adopted as is in the synthesized waveform.

(2) The intensity detected during a period in which the waveform data has no deficient data among the intensities detected in each sweep is adopted as the light intensity at overlapping wavelengths in the waveforms detected in two or more sweeps. The period in which the waveform data has no deficient data is the period, within the period during which the gate signal is on, that occurs after a predetermined time elapses from when the gate signal turns on.
Conversely, the period in which the waveform data has deficient data is the period, within the period during which the gate signal is on, lasting a predetermined time from when the gate signal turns on.

The measurement unit 13 may store at least one of the period in which the waveform data has no deficient data and the period in which the waveform data has deficient data, used in (2) above, in association with the waveform data when performing each sweep and refer to the stored waveform data when synthesizing the waveform data.

The measurement unit 13 may appropriately set a predetermined time for identifying the period in which the waveform data has no deficient data or does have deficient data. The measurement unit 13 may accept user input to set the predetermined time and set the value inputted by the user as the predetermined time. The measurement unit 13 may analyze a waveform in which the intensity of a test signal whose intensity changes in a step-like manner from LO to HI is detected and may set the predetermined time based on the length of the period from when the intensity of the test signal becomes HI until the intensity of the waveform stabilizes.

With this configuration, deficient data is eliminated in the synthesized waveform. Consequently, the quality of the waveform improves.

In a case in which the delay time is increased in the order in which the plurality of sweeps is performed, the measurement unit 13 may synthesize the waveforms based on rule (3) indicated below instead of (2) above.

(3) The intensity detected during a sweep performed later is adopted as the light intensity at overlapping wavelengths in the waveforms detected in two or more sweeps, regardless of whether the waveform data has deficient data. In other words, the intensity of the synthesized waveform is overwritten by the intensity detected in the later sweep.

By overwriting with the intensity detected in a later sweep, the waveforms acquired in previously performed sweeps need not be stored. Consequently, the process of synthesizing the waveform is simplified. In addition, the storage capacity required to store the waveforms is reduced.

Instead of (2) or (3) above, the measurement unit 13 may synthesize waveforms based on the rule indicated as (4) below, which is a combination of (2) and (3) above.

(4) The intensity detected during a sweep performed later, among intensities detected during a period in which the waveform data has no deficient data, is adopted as the light intensity at overlapping wavelengths in the waveforms detected in two or more sweeps.

Instead of (2) to (4) above, the measurement unit 13 may synthesize waveforms based on the rule indicated as (5) below.

(5) The larger value among intensities detected during each sweep is adopted as the light intensity at overlapping wavelengths in the waveforms detected in two or more sweeps, regardless of whether the waveform data has deficient data.

With this configuration, deficient data is eliminated in the synthesized waveform. Consequently, the quality of the waveform improves.

Instead of (2) to (5) above, the measurement unit 13 may synthesize waveforms based on the rule indicated as (6) below, which is a combination of (2) and (5) above.

(6) The larger value among intensities detected during a period in which the waveform data has no deficient data is adopted as the light intensity at overlapping wavelengths in the waveforms detected in two or more sweeps.

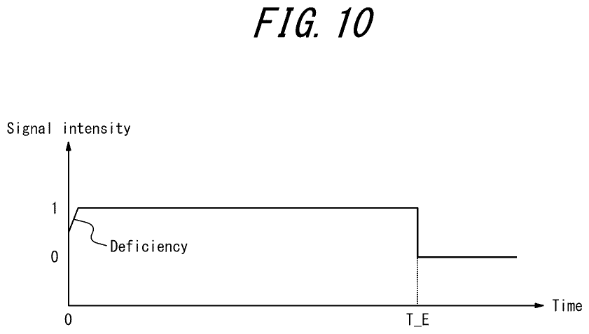

The measurement unit 13 displays a synthesized waveform of the optical spectrum of the pulsed light on the display 14, as illustrated in FIG. 10. In the synthesized waveform, a deficiency remains on the shortest wavelength side of the measurement wavelength range, but deficient data is eliminated in the rest of the range.

The deficiency on the shortest wavelength side of the measurement wavelength range is difficult to eliminate, because it corresponds to the rise of the pulse in each sweep. In the optical spectrum analyzer 10, the grating of the light detector 12 may be configured to move from a wavelength shorter than the minimum wavelength in the measurement wavelength range. By the wavelength at which the sweep operation starts being set shorter than the minimum wavelength in the measurement wavelength range, the deficiency at the shortest wavelength side of the measurement wavelength range can be eliminated.

In the operation example described above, the acquisition of data in the measurement wavelength range was completed by performance of four sweep operations. The number of sweep operations required to complete the acquisition of data in the measurement wavelength range is calculated by rounding the value calculated as 100/{X×(1−Y/100)} up to the nearest whole number. For example, if the pulsed light duty ratio (X) is 25%, and the overlap width (Y) is 50%, the number of sweeps is calculated to be 8 by calculating 100/{25×(1−50/100)}.

If the wavelengths of the waveform acquired in each sweep do not overlap at all, i.e., if the overlap width (Y) is 0%, the required number of sweeps is calculated by calculating 100/X. If the calculation result of the required number of sweeps has figures after the decimal point, the calculation result is rounded up to the nearest whole number. For example, if the duty ratio of the pulsed light is 25%, the required number of sweeps is calculated to be 4 by calculating 100/25. If, for example, the duty ratio of the pulsed light is 30%, the required number of sweeps is calculated to be 4 by calculating 100/30 and rounding up to the nearest whole number. On the other hand, as described below, the larger the overlap width, the more sweeps are required.

After performing the procedure in step S9, the measurement unit 13 ends performance of the procedures in the flowchart in FIG. 5. After performing the procedure in step S9, the measurement unit 13 may start performance of the procedures in the flowchart in FIG. 5 again. In this case, the user may set the overlap width in the procedure in step S1 while looking at the synthesized waveform displayed as the result of the previous operations in the flowchart in FIG. 5. In a case in which the synthesized waveform has deficiencies, the user may set the overlap width to a larger value so as to eliminate the deficiencies the next time the operations in the flowchart in FIG. 5 are performed. Conversely, in a case in which no deficiencies are contained in the synthesized waveform, the user may set the overlap width to a smaller value so as to shorten the measurement time the next time the operations in the flowchart in FIG. 5 are performed.

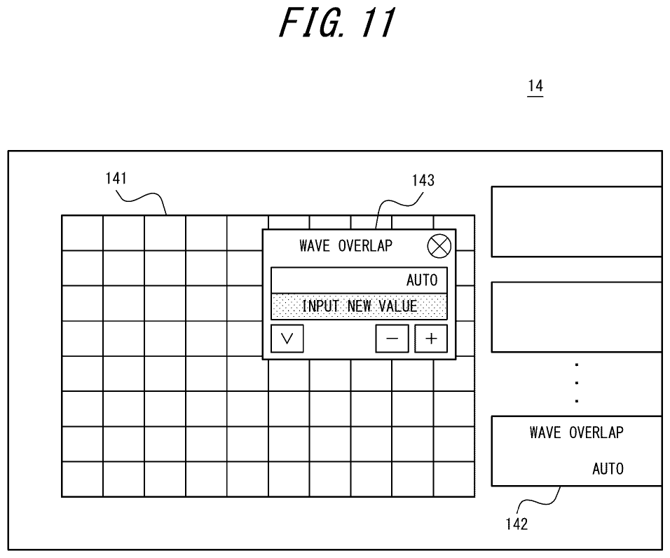

To allow the user to set the overlap width, the optical spectrum analyzer 10 may display a setting window 143 as a GUI for setting the overlap width on the display 14, as illustrated in FIG. 11. The setting window 143 may be displayed when an operation such as touching or clicking is inputted to a setting interface 142 that displays the overlap width setting value. The setting window 143 may be displayed above the waveform display 141, which displays the waveform, or outside the waveform display 141. The setting window 143 may be configured to accept input of a value to be set as Y % representing the overlap width. For example, the setting window 143 may be configured to allow input of values from 1% to 99%.

The optical spectrum analyzer 10 may accept setting input for the overlap width from the user in the setting window 143 while the synthesized waveform is displayed on the waveform display 141. By input for setting the overlap width being accepted while the synthesized waveform is being displayed, the user can more easily determine how to set the overlap width. Consequently, user convenience improves.

The optical spectrum analyzer 10 may accept setting input for the overlap width from the user in the setting window 143 while performing a plurality of sweeps. By input for setting the overlap width being accepted while the plurality of sweeps is being performed, the user can immediately check how the setting of the overlap width changes the synthesized waveform and can more easily determine how to set the overlap width. Consequently, user convenience improves.

The setting window 143 may be configured to allow input of a setting represented as AUTO. In a case in which the overlap width is set to AUTO, the measurement unit 13 automatically sets the overlap width. The measurement unit 13 may, for example, set the overlap width to 5%. The measurement unit 13 may analyze the deficient range of the waveform acquired in each sweep and automatically set the overlap width so as to eliminate the deficiencies from the synthesized waveform.

Before completing the acquisition of data in the measurement wavelength range, the measurement unit 13 may sequentially synthesize the waveforms acquired in each sweep and display the result on the display 14 as measurement progress.

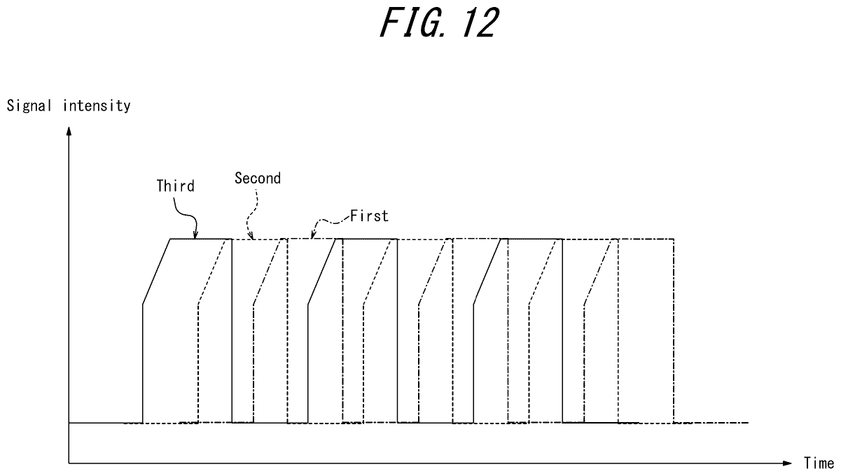

The measurement unit 13 may display the waveforms acquired in each sweep in a manner distinguishable from each other on the display 14, as illustrated in FIG. 12. In the example in FIG. 12, the waveforms acquired in each of the three sweeps are displayed with different line types from each other. The waveforms acquired in each of the sweeps may be displayed so as to be distinguishable from each other by the color of the lines. The waveforms acquired in each sweep may be displayed in various other ways apart from line type or line color. By the waveforms acquired in each of the sweeps being displayed in a manner distinguishable from each other, the user can more easily determine how to set the overlap width. Consequently, user convenience improves.

The measurement unit 13 extends the delay time in order as the number of sweeps increases, but the measurement unit 13 may reduce the delay time while repeatedly performing sweeps. The measurement unit 13 sets the delay time so that the difference in delay time between each sweep is equal, but the delay time may be set so that the difference in delay time between each sweep is different.

The measurement unit 13 may determine the number of times to perform the sweep based on the pulse width and overlap width. Having the measurement unit 13 determine the number of times to perform the sweep makes it easier to understand the measurement time. The measurement unit 13 may set the delay time so that the difference in delay time between each sweep is equal according to the determined number of sweeps.

### SUMMARY

As described above, the optical spectrum analyzer 10 according to the present disclosure detects the waveform of the optical spectrum of pulsed light in different wavelength ranges in each sweep by setting the overlap width of the waveform to be acquired in each sweep and by varying the timing at which to start each sweep when performing a plurality of sweeps. The optical spectrum analyzer 10 generates the waveform of the optical spectrum of the pulsed light by synthesizing the waveforms detected in each sweep so that the deficiency of the waveform that occurs at the initial rise of the pulsed light is eliminated. The optical spectrum analyzer 10 is configured so that the user can set the overlap width while viewing the waveform of the optical spectrum. The balance between the measurement time of the optical spectrum and the quality of the measured waveform is thereby adjusted. User convenience also improves.

In the above embodiments, the overlap width is expressed as a percentage of the length of the pulse width of the pulsed light, but the overlap width may be expressed in various other ways, such as a percentage of the length of the pulse period of the pulsed light.

Although embodiments of the present disclosure have been described through drawings and examples, it is to be noted that various changes and modifications can be made by those skilled in the art on the basis of the present disclosure. Therefore, such changes and modifications are to be understood as included within the scope of the present disclosure. For example, the functions and the like included in the various components may be reordered in any logically consistent way. Furthermore, components may be combined into one or divided.

1. A pulsed light measurement method for measuring an optical spectrum of pulsed light, comprising:
setting an overlap width of wavelengths at which light intensity is measured in each sweep among a plurality of sweeps performed in a measurement wavelength range of the optical spectrum;
starting each sweep among the plurality of sweeps after a delay time, determined based on the overlap width, elapses after detection of a trigger of a gate signal synchronized with the pulsed light; and
synthesizing and displaying the optical spectrum from a plurality of waveforms obtained by performing the plurality of sweeps.

2. The pulsed light measurement method according to claim 1, wherein when the optical spectrum is synthesized from the plurality of waveforms, an intensity detected during a period in which waveform data has no deficient data is adopted as the light intensity at overlapping wavelengths in the plurality of waveforms.

3. The pulsed light measurement method according to claim 1, wherein when the optical spectrum is synthesized from the plurality of waveforms in a case in which the delay time is increased in an order in which the plurality of sweeps is performed, an intensity detected during a later sweep is adopted as the light intensity at overlapping wavelengths in the plurality of waveforms.

4. The pulsed light measurement method according to claim 1, wherein when the optical spectrum is synthesized from the plurality of waveforms in a case in which the delay time is increased in an order in which the plurality of sweeps is performed, an intensity detected during a later sweep, among intensities detected during a period in which waveform data has no deficient data, is adopted as the light intensity at overlapping wavelengths in the plurality of waveforms.

5. The pulsed light measurement method according to claim 1, wherein when the optical spectrum is synthesized from the plurality of waveforms, a larger value is adopted as the light intensity at overlapping wavelengths in the plurality of waveforms.

6. The pulsed light measurement method according to claim 1, wherein when the optical spectrum is synthesized from the plurality of waveforms, a larger value among intensities detected during a period in which waveform data has no deficient data is adopted as the light intensity at overlapping wavelengths in the plurality of waveforms.

7. The pulsed light measurement method according to claim 1, further comprising setting the overlap width as a percentage of a pulse width of the pulsed light.

8. The pulsed light measurement method according to claim 7, further comprising determining a number of times to perform the sweep based on the pulse width and the overlap width.

9. The pulsed light measurement method according to claim 1, further comprising displaying the plurality of waveforms obtained by the plurality of sweeps in a distinguishable manner.

10. The pulsed light measurement method according to claim 1, further comprising accepting input for setting the overlap width while performing the plurality of sweeps.

11. The pulsed light measurement method according to claim 1, further comprising accepting input for setting the overlap width while displaying a waveform of the optical spectrum.

12. A non-transitory computer readable medium storing a pulsed light measurement program configured to cause an optical spectrum analyzer for measuring an optical spectrum of pulsed light to perform operations, the operations comprising:
setting an overlap width of wavelengths at which light intensity is measured in each sweep among a plurality of sweeps performed in a measurement wavelength range of the optical spectrum;
starting each sweep among the plurality of sweeps after a delay time, determined based on the overlap width, elapses after detection of a trigger of a gate signal synchronized with the pulsed light; and
synthesizing and displaying the optical spectrum from a plurality of waveforms obtained by performing the plurality of sweeps.

13. An optical spectrum analyzer comprising:
a measurement unit configured to measure an optical spectrum of pulsed light; and
a light detector configured to detect a light intensity at each wavelength of the pulsed light, wherein
the measurement unit is configured to set an overlap width of wavelengths at which light intensity is measured in each sweep among a plurality of sweeps performed in a measurement wavelength range of the optical spectrum,
the light detector is configured to start each sweep among the plurality of sweeps after a delay time, determined based on the overlap width, elapses after detection of a trigger of a gate signal synchronized with the pulsed light, and
the measurement unit is configured to synthesize and display the optical spectrum from a plurality of waveforms obtained by performing the plurality of sweeps.
